(19) United States
(12) Patent Application Publication
(10) Pub. No.: US 2005/0135941 A1
(43) Pub. Date: Jun. 23, 2005

(54) Hermetic compressor

(75) Inventor: Seung Don Seo, Suwon-Si (KR)

Correspondence Address: Ladas & Parry, 26 West 61st Street, New York, NY, 10023, US

(73) Assignee: SAMSUNG GWANG JU ELECTRONICS CO., LTD.

(21) Appl. No.: 10/844,238

(22) Filed: May 12, 2004

(30) Foreign Application Priority Data
Dec. 22, 2003 (KR) 2003-95014

(51) Int. Cl. F02M 35/00; F04B 39/00

(52) U.S. Cl. 417/312; 417/902; 417/572

(57) ABSTRACT

A hermetic compressor includes an exhaust pipe coupled to an exhaust port of an exhaust muffler. The exhaust pipe includes a support part to support the exhaust pipe on an outer surface of the exhaust muffler, and a flare part to support the exhaust pipe on an inner surface of the exhaust muffler. The support part outwardly extends from the exhaust pipe in a radial direction of the exhaust pipe. An inside end of the exhaust pipe is flared in a radial direction of the exhaust pipe, thus forming the flare part.

### CROSS-REFERENCE TO RELATED APPLICATION

This application claims the benefit of Korean Patent Application No. 2003-95014, filed Dec. 22, 2003 in the Korean Intellectual Property Office, the disclosure of which is incorporated herein by reference.

### BACKGROUND OF THE INVENTION

1. Field of the Invention

The present invention relates, in general, to hermetic compressors and, more particularly, to a hermetic compressor having an exhaust muffler and an exhaust pipe, coupled to the exhaust muffler, to exhaust a compressed refrigerant to an outside of the exhaust muffler.

2. Description of the Related Art

Generally, a hermetic compressor is a machine that draws and compresses a refrigerant in a hermetic casing, prior to discharging the compressed refrigerant to an outside of the hermetic casing. The hermetic compressor includes a compressing unit to compress the refrigerant, and a drive unit to drive the compressing unit.

The compressing unit is provided on a lower portion of the hermetic casing, and includes a cylinder block, a piston, and a cylinder head. The cylinder block defines a compression chamber. A drive power of the drive unit is transmitted to the piston, thus reciprocating the piston in the compression chamber. The cylinder head is mounted to an end of the cylinder block, and has a suction chamber and an exhaust chamber which communicate with the outside of the hermetic casing.

A valve plate is provided at a junction between the cylinder block and the cylinder head, with an inlet port and an outlet port being respectively provided on predetermined portions of the valve plate to allow the suction chamber and the exhaust chamber to communicate with the compression chamber. An intake valve and a discharge valve are mounted to the inlet port and the outlet port, respectively, to control a flow of the refrigerant.

Further, an exhaust muffler is provided at each of opposite ends of the cylinder block to reduce noise generated when the refrigerant is discharged from the hermetic casing. Meanwhile, the refrigerant compressed in the compression chamber sequentially passes through the discharge valve of the valve plate, the exhaust chamber of the cylinder head, and the exhaust muffler. Thereafter, the refrigerant is discharged to an outside of the compressor through the exhaust pipe coupled to the exhaust muffler.

In a conventional hermetic compressor, in order to couple the exhaust pipe to the exhaust muffler, a stepped depression is provided on a predetermined portion of the exhaust muffler, and a sleeve having a shape to correspond to the stepped depression is press-fitted into the stepped depression. Thereafter, the exhaust pipe is inserted into a hollow part of the sleeve, and then the sleeve is compressed using a caulking jig to prevent the exhaust pipe from being removed from the sleeve.

However, the conventional hermetic compressor has a problem in that the sleeve must be used to couple the exhaust pipe to the exhaust muffler, thus causing an increase in manufacturing costs of the hermetic compressor.

The conventional hermetic compressor has another problem in that the sleeve and the stepped depression which have complicated shapes are individually provided, so that it is difficult to manufacture the hermetic compressor, and productivity of the hermetic compressor is reduced.

### SUMMARY OF THE INVENTION

Accordingly, it is an aspect of the present invention to provide a hermetic compressor which is capable of easily and firmly coupling an exhaust pipe to an exhaust muffler.

Additional aspects and/or advantages of the invention will be set forth in part in the description which follows and, in part, will be obvious from the description, or may be learned by practice of the invention.

The above and/or other aspects are achieved by a hermetic compressor, including a compression chamber, an exhaust muffler to reduce pulsations of a refrigerant compressed in the compression chamber, an exhaust port provided at a predetermined portion of the exhaust muffler to exhaust the refrigerant from an inside of the exhaust muffler to an outside of the exhaust muffler, and an exhaust pipe inserted into the exhaust port. The exhaust pipe includes a support part to support the exhaust pipe on an outer surface of the exhaust muffler, and a flare part provided at an inside end of the exhaust pipe to support the exhaust pipe on an inner surface of the exhaust muffler. The flare part is flared in a radial direction thereof.

According to an aspect of the invention, the inside end of the exhaust pipe may be flared by a caulking jig, with an end of the caulking jig facing the inside end of the exhaust pipe being gradually decreased in a diameter toward the exhaust pipe.

In another aspect of this embodiment, the support part may outwardly extend from the exhaust pipe in a radial direction of the exhaust pipe.

In yet another aspect of this embodiment, the exhaust muffler may include a depressed seat which is provided on the outer surface of the exhaust muffler at a portion around the exhaust port, with a washer being provided in the depressed seat to airtightly seal a gap between the exhaust pipe and the exhaust muffler.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a side sectional view of a hermetic compressor, according to an embodiment of the present invention;

FIG. 2 is a plan view of the hermetic compressor of FIG. 1;

FIG. 3 is a sectional view to show an exhaust pipe and an exhaust muffler included in the hermetic compressor of FIG. 1, in which the exhaust pipe is coupled to the exhaust muffler; and

FIGS. 4 and 5 are sectional views to show processes of coupling the exhaust pipe to the exhaust muffler of FIG. 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout. The embodiment is described below in order to explain the present invention by referring to the figures.

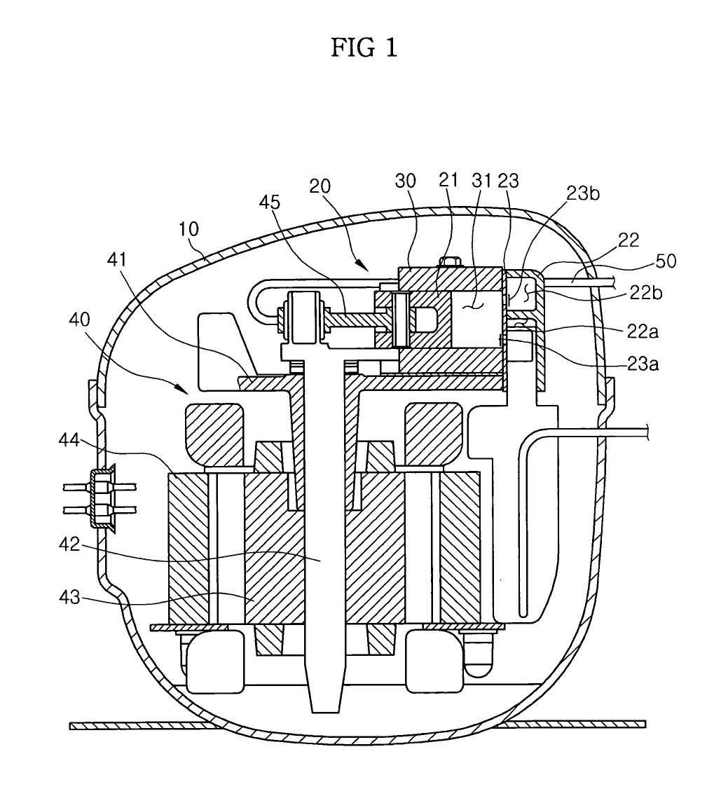

FIG. 1 is a sectional view to show a construction of a hermetic compressor, according to an embodiment of the present invention.

Referring to FIG. 1, the hermetic compressor includes a hermetic casing 10. A compressing unit 20 and a drive unit 40 are housed in the hermetic casing 10. The compressing unit 20 functions to compress a refrigerant. The drive unit 40 generates a drive power to drive the compressing unit 20.

The compressing unit 20 includes a cylinder block 30 which defines a compression chamber 31 therein, and a piston 21 which reciprocates in the compression chamber 31 to draw, compress, and discharge the refrigerant. A cylinder head 22 is mounted to an end of the cylinder block 30, with a suction chamber 22a and an exhaust chamber 22b being provided on the cylinder head 22. A valve plate 23 is interposed between the cylinder block 30 and the cylinder head 22. The valve plate 23 includes an intake valve 23a to allow the refrigerant to be drawn into the compression chamber 31, and a discharge valve 23b to allow the refrigerant to be discharged from the compression chamber 31.

The drive unit 40 is provided to reciprocate the piston 21, thus compressing the refrigerant in the compressing unit 20. The drive unit 40 includes a rotating shaft 42 which is rotatably installed at a frame 41, and a rotor 43 which operates in conjunction with the rotating shaft 42. The rotor 43 is spaced apart from a stator 44 by a predetermined distance and rotated by an electromagnetic field generated along the stator 44 when an electric power is applied to the stator 44. Further, a connecting rod 45 is provided above the rotating shaft 42. The connecting rod 45 is rotatably connected at a first end thereof to the rotating shaft 42, and at a second end thereof to the piston 21 to rectilinearly reciprocate the piston 21.

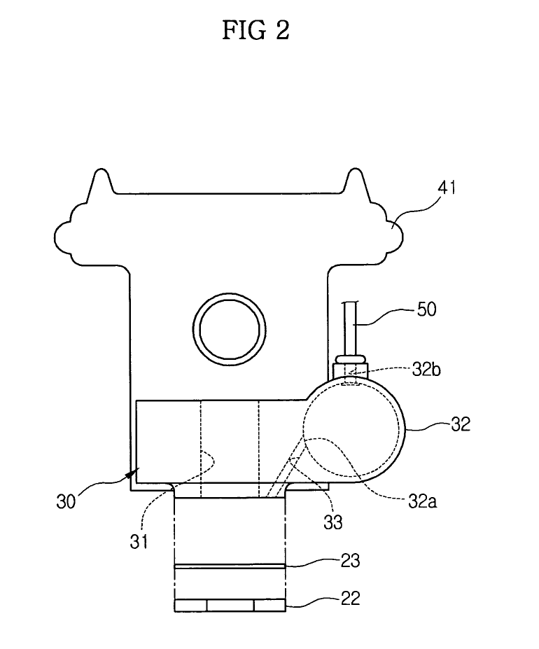

As shown in FIG. 2, an exhaust muffler 32 is provided on at least one end of opposite ends of the cylinder block 30 to reduce pulsations when the refrigerant is discharged to an outside of the compressor.

The exhaust muffler 32 defines a space therein, and communicates with the compression chamber 31 by means of a guide passage 33. In this case, the guide passage 33 is provided in the cylinder block 30 to be spaced apart from the compression chamber 31. A first end of the guide passage 33 is opened toward the cylinder head 22, and a second end of the guide passage 33 forms a suction port 32a which communicates with the exhaust muffler 32.

Further, an exhaust port 32b is provided on a predetermined portion of the exhaust muffler 32 to exhaust the refrigerant from the compression chamber 31. An exhaust pipe 50 is coupled to the exhaust port 32b, and guides the refrigerant to the outside of the compressor.

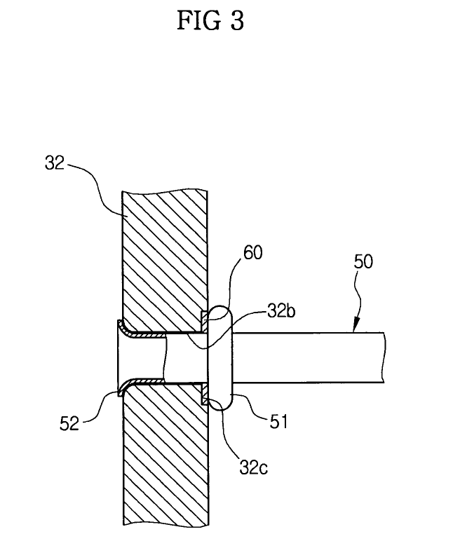

Referring to FIG. 3, the exhaust pipe 50 is inserted into the exhaust port 32b provided on the exhaust muffler 32.

The exhaust pipe 50 includes a support part 51 and a flare part 52. In this case, the support part 51 supports the exhaust pipe 50 on an outer surface of the exhaust muffler 32, and the flare part 52 supports the exhaust pipe 50 on an inner surface of the exhaust muffler 32. Further, the support part 51 outwardly extends from the exhaust pipe 50 in a radial direction of the exhaust pipe 50. An inside end of the exhaust pipe 50 is flared in a radial direction of the exhaust pipe 50, thus forming the flare part 52.

Both the support part 51 and the flare part 52 allow the exhaust pipe 50 to be firmly coupled to the exhaust port 32b of the exhaust muffler 32.

Further, a washer 60 is interposed between the support part 51 of the exhaust pipe 50 and an outer surface of the exhaust muffler 32 so as to airtightly seal a gap therebetween. A depressed seat 32c is provided on the outer surface of the exhaust muffler 32 at a portion around the exhaust port 32b so that the washer 60 is seated in the depressed seat 32c.

The process of coupling the exhaust pipe 50 to the exhaust muffler 32 included in the hermetic compressor according to the present invention will be described in the following.

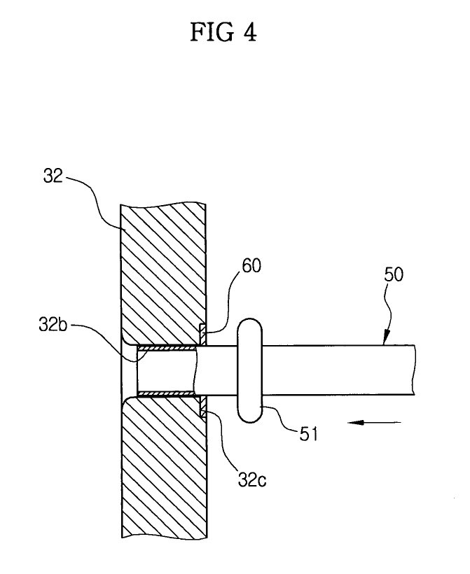

As shown in FIG. 4, the washer 60 is seated in the depressed seat 32c provided on the outer surface of the exhaust muffler 32, and the exhaust pipe 50 is inserted into the exhaust port 32b.

The exhaust pipe 50 includes the support part 51 which outwardly extends from the exhaust pipe 50 in the radial direction thereof. In this case, the exhaust pipe 50 having a shape of a general pipe is compressed from opposite ends of the exhaust pipe 50 toward an intermediate position of the exhaust pipe 50, thus forming the support part 51.

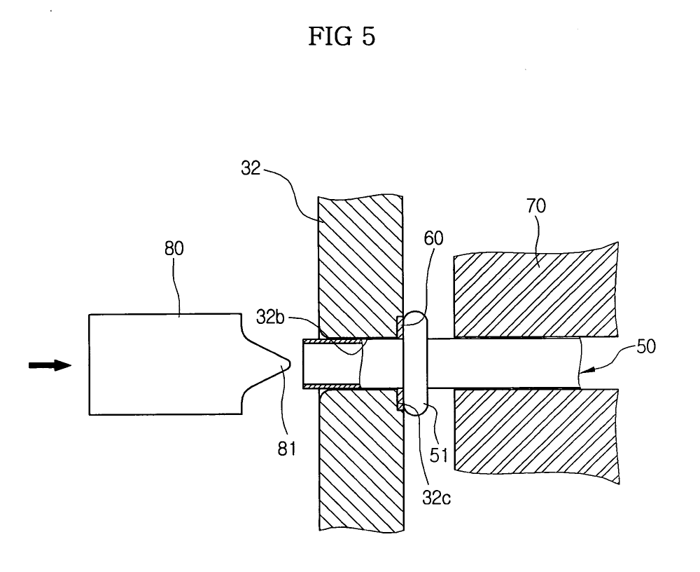

After the exhaust pipe 50 is completely inserted into the exhaust port 32b so that the support part 51 is supported on the outer surface of the exhaust muffler 32, as shown in FIG. 5, the inside end of the exhaust pipe 50 is flared by a caulking jig 80 while an outside part of the exhaust pipe 50 outside the support part 51 is held by a holding jig 70. In this case, the caulking jig 80 has a press part 81 at an end of the caulking jig 80 facing the inside end of the exhaust pipe 50. A diameter of the press part 81 is gradually decreased toward the exhaust pipe 50.

In a detailed description, as the press part 81 of the caulking jig 80 presses the inside end of the exhaust pipe 50, the inside end of the exhaust pipe 50 forms the flare part 52, as shown in FIG. 3, so that the flare part 52 supports the exhaust pipe 50 on the inner surface of the exhaust muffler 32.

This invention has been described herein with reference to a case where the exhaust pipe 50 is mounted to the exhaust muffler 32 provided on the cylinder block 30. But, the exhaust pipe 50 may be directly mounted to the hermetic casing 10. In this case, the exhaust pipe 50 is mounted to the hermetic casing 10 in a same manner of coupling the exhaust pipe 50 to the exhaust muffler 32.

As is apparent from the above description, the present invention provides a hermetic compressor, which is constructed so that a support part of an exhaust pipe supports the exhaust pipe on an outer surface of an exhaust muffler and a flare part of the exhaust pipe supports the exhaust pipe on an inner surface of the exhaust muffler, thus allowing the exhaust pipe to be firmly coupled to the exhaust muffler.

In the hermetic compressor of the present invention, the exhaust pipe is provided with a support part and a flare part so that the exhaust pipe is directly coupled to the exhaust muffler without any additional parts, such as a sleeve, differently from a conventional method where an exhaust pipe is coupled to an exhaust muffler using the sleeve. Thus, manufacturing costs of the hermetic compressor are reduced and a smaller number of parts are required, thus simplifying a working process and thereby enhancing productivity of the hermetic compressor.

Although an embodiment of the present invention has been shown and described, it would be appreciated by those skilled in the art that changes may be made in these embodiments without departing from the principles and spirit of the invention, the scope of which is defined in the claims and their equivalents.

1. A hermetic compressor, comprising:
a compression chamber;
an exhaust muffler to reduce pulsations of a refrigerant compressed in the compression chamber;
an exhaust port provided at a predetermined portion of the exhaust muffler to exhaust the refrigerant from an inside of the exhaust muffler to an outside of the exhaust muffler; and
an exhaust pipe inserted into the exhaust port, the exhaust pipe comprising:
a support part to support the exhaust pipe on an outer surface of the exhaust muffler; and
a flare part provided at an inside end of the exhaust pipe to support the exhaust pipe on an inner surface of the exhaust muffler, the flare part being flared in a radial direction thereof.

2. The hermetic compressor according to claim 1, wherein the inside end of the exhaust pipe is flared by a caulking jig, with an end of the caulking jig facing the inside end of the exhaust pipe being gradually decreased in a diameter toward the exhaust pipe.

3. The hermetic compressor according to claim 1, wherein the support part outwardly extends from the exhaust pipe in a radial direction of the exhaust pipe.

4. The hermetic compressor according to claim 1, wherein the exhaust muffler comprises a depressed seat which is provided on the outer surface of the exhaust muffler at a portion around the exhaust port, with a washer being provided in the depressed seat to airtightly seal a gap between the exhaust pipe and the exhaust muffler.
